(19) United States
(12) Patent Application Publication
(10) Pub. No.: US 2004/0252689 A1
(43) Pub. Date: Dec. 16, 2004

(54) Memory system with reduced pin count

(76) Inventors: Bok-Gue Park, Suwon-si (KR); Ki-Chul Chun, Suwon-si (KR); Jong-Hyun Choi, Suwon-si (KR); Hyun-Soon Jang, Seoul (KR); Woo-Seop Jeong, Yongin-si (KR)

Correspondence Address: VOLENTINE FRANCOS, & WHITT PLLC, ONE FREEDOM SQUARE, 11951 FREEDOM DRIVE SUITE 1260, RESTON, VA, 20190, US

(21) Appl. No.: 10/865,887

(22) Filed: Jun. 14, 2004

(30) Foreign Application Priority Data
Jun. 11, 2003 (KR) 2003-37676
Oct. 31, 2003 (KR) 2003-76953

(51) Int. Cl. H04L 12/56

(52) U.S. Cl. 370/389

(57) ABSTRACT

A memory system includes a synchronous memory responding to a clock signal and a memory controller generating a chip selection signal, a clock signal, and data packets including commands and addresses. The memory controller includes a packet controller is synchronously operable with the clock signal and converting the data packets into address and control signals adapted to a communication protocol for the synchronous memory when the chip selection signal is active.

### FIELD OF THE INVENTION

The present invention relates generally to data processing systems. More particularly, the present invention relates to memory systems adapted for use within data processing systems, and further adapted to effectively communicate data packets.

A claim of priority is made to Korean Patent Applications, No. 2003-37676 filed on Jun. 11, 2003, and No. 2003-76953 filed on Oct. 31, 2003, the disclosures of which are hereby incorporated by reference in their entirety.

### BACKGROUND OF THE INVENTION

Over the past several decades, technology developments related to the design and fabrication of semiconductor devices have struggled to keep pace with the often competing demands of device miniaturization and expanding fields of use, such as, mobile telecommunications, personal digital assistants, third-generation mobile phones, digital cameras, etc. The pressure to continually improve semiconductor fabrication techniques has become increasing intense as complex, ultra-miniaturized devices have extended the development cycle time and increased development costs. The use of chip sets having two or more integrated circuit “chips,” is one approach to mitigating the pressures associated with developing next generation semiconductor devices. Chip sets have proved particularly useful in addressing the miniaturization demands and flexible implementation requirements associated with many mobile telecommunications applications.

The term “multi-chip package (MCP)” refers to a combination of various chips typically including one or more memory chips, such as flash memories, static RAMs, dynamic memories, pseudo RAMs, etc. Memory chips are usually single chip packages, and have been conventionally manufactured as independent devices having a high degree of reliability. The conventional MCP enjoys obvious advantages including reduced component volumes. Indeed, the use of MCPs in certain mobile applications result in a 50+% reduction in component volume, as compared with competing designs employing single chips. Further, MCPs tend to simplify the complexity of interconnections, reduce prime costs, and enhance productivity.

Additionally, system-in-package (SIP) technology has been adapted to the structural simplification of mobile products, where non-memory devices and memory devices are embedded together within a single package. In a typical SIP, integrated circuit chips, including memory chips and non-memory chips, are stacked and interconnected to each other in a topological dimension. Such stacks of integrated circuit chips in a single package offer several advantages including shortened development cycles, reduced product cost, and enhanced data transmission rates. SIP technology also tends to decrease the overall architectural volume of a device.

Unfortunately, devices implemented in accordance with conventional MCP and/or SIP technologies inevitably include a great multiplicity of pin connections, such as address pins, data pins, control pins, and so on. The use of so many pins actually becomes an obstacle to the development of a coherent, efficient a system architecture. This is particularly true for mobile applications employing memory systems incorporated within MCP and/or SIP designs.

### SUMMARY OF THE INVENTION

Recognizing the foregoing, the present invention provides a memory system readily adaptable to implementation using MCP or SIP in which the overall number of connection (e.g., a combination of input and output pins) pins is reduced over what would other wise be expected in conventional memory system designs. Accordingly, memory systems designed in accordance with the present invention are particularly well suited for mobile applications.

Thus, in one aspect the present invention provides a memory system comprising a packet controller, responsive to a packet enable signal and a clock signal, receiving data packets from a memory controller via a plurality of input pins, converting the data packets into address and control signals, and outputting the address and control signals via a plurality of output pins, and a synchronous memory receiving the address and control signals in response to the clock signal, wherein the plurality of output pins is fewer in number than the plurality of input pins.

In another aspect, the present invention provides a memory system comprising; a packet controller, comprising; a first pin receiving a chip selection signal, a second pin receiving a clock signal; a plurality of input pins receiving data packets from a memory controller, and a plurality of output pins, wherein in response to a packet enable signal and the clock signal, the packet controller receives the data packets through the plurality of input pins, converts the data packets into address and control signals, and outputs the address and control signals via the plurality of output pins, and a synchronous memory receiving the address and control signals in response to the clock signal.

In yet another aspect, the present invention provides a memory system comprising; a synchronous memory responsive to a clock signal, a memory controller generating serial data packets and the clock signal, and a packet controller receiving the serial data packets and converting and multiplexing the serial data packets into parallel data packets comprising address and control signals adapted to control operation of the synchronous memory. Where the synchronous memory and the packet controller are assembled in a single package. The package may be a multi-chip package (MCP) or a system-in-package (SIP).

In yet another aspect, the present invention provides a memory system comprising; a memory controller generating a clock signal, a chip selection signal, and a plurality of data packets, and a packet controller, and a synchronous memory storing data in responsive to the control signals, the data signals, and the clock signal.

Where the packet controller comprises; a control circuit generating a plurality of pulse signals in response to the chip selection signal, a plurality of registers each latching data bits from a corresponding data packet in response to the pulse signals and thereafter outputting parallel data signals, and a signal generator outputting control signals in response to the parallel data signals provided at least one of the plurality of registers.

In still another aspect, the present invention provides a memory system comprising; a memory controller generating a clock signal, a plurality of chip selection signals, and a plurality of data packets; and a plurality of circuits, each circuit comprising a packet controller and synchronous memory, being respectively selected by the chip selection signals, and being operable at a frequency defined in relation to the clock signal.

Where the packet controller receives the data packets, at least one of the data packets comprises data defining commands and addresses to be applied to the synchronous memory, and where the memory controller directly exchanges data with each synchronous memory in the plurality of circuits.

### BRIEF DESCRIPTION OF THE DRAWINGS

The forgoing and other objects, features and advantages of the invention will be apparent from the more particular description of a preferred embodiment of the invention, as illustrated in the accompanying drawings in which like reference characters refer to the same parts throughout the different views. The drawings are not necessarily to scale, emphasis instead being placed upon illustrating the principles of the invention:

FIG. 1 is a block diagram illustrating a functional structure of a memory system according to a first embodiment of the invention;

FIG. 2 is a block diagram illustrating a control block and a packet controller shown in FIG. 1;

FIG. 3 is a timing diagram of signals provided from the control block of FIG. 2;

FIGS. 4A through 4E are circuit diagrams illustrating serial-to-parallel registers shown in FIG. 2;

FIG. 5 is a chart showing the composition of a data packet according to the first embodiment of the invention;

FIG. 6 is a block diagram illustrating a functional structure of a synchronous memory shown in FIG. 1;

FIG. 7 is a timing diagram showing operations of the packet controller and the synchronous memory according to the first embodiment of the invention;

FIG. 8 a block diagram illustrating a functional structure of a memory system according to a second embodiment of the invention;

FIG. 9 is a block diagram illustrating a control block and a packet controller shown in FIG. 8;

FIGS. 10 and 11 are charts showing the compositions of data packets according to the second embodiment of the invention;

FIG. 12 is a timing diagram showing an auto-refresh operation according to the second embodiment of the invention; and

FIG. 13 is a block diagram illustrating a functional structure of a memory system according to a third embodiment of the invention

### DESCRIPTION OF THE PREFERRED EMBODIMENT(s)

It should be understood that the description of the preferred embodiment(s) that follows is illustrative in nature. Within the following detailed description, specific details are set forth in order to provide a thorough understanding of the making and use of the present invention. However, those of ordinary skill in the art will recognize that the present invention extends to many adaptations, modifications, and alternate implementations.

Now, practical embodiments of the invention will be explained in conjunction with the drawings.

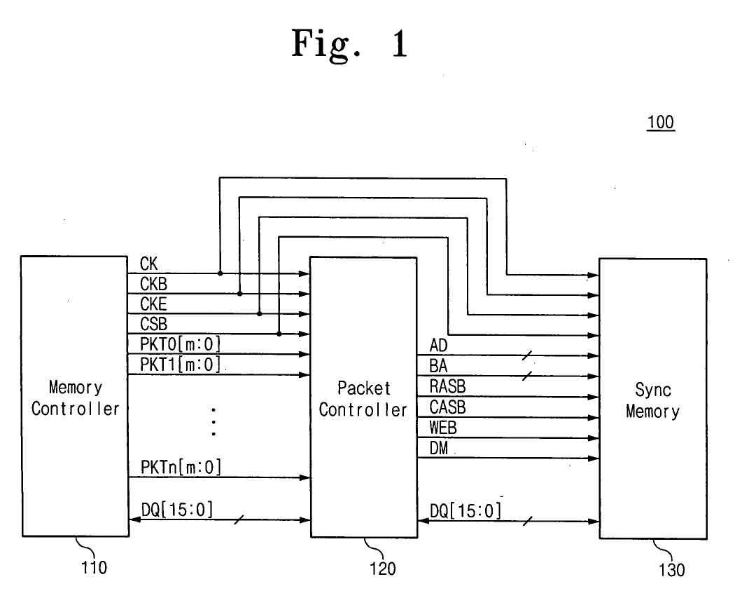

FIG. 1 is a block diagram illustrating the functional structure of a memory system designed in accordance with one embodiment of the present invention. Referring to FIG. 1, a memory system 100 includes a memory controller 110, a synchronous memory 130, and a packet controller 120 interfacing memory controller 110 with synchronous memory 130. Synchronous memory 130 may take many specific forms, including as an example, double (or dual) data rate synchronous DRAM (DDR-SDRAM), or similar types of synchronous memories. In memory system 100, packet controller 120 and synchronous memory 130 are preferably assembled in accordance with the conventional dictates of MCP and/or SIP technologies. Alternatively, these components may be implemented in a single package using conventionally understood system-on-chip (SOC) technologies. Both packet controller 120 and synchronous memory 130 are driven by clock signals CK and CKB provided from memory controller 110. Specifically, memory 130 conducts a data burst operations in synchronization (hereafter “sych”) with clock signals CK and CKB. Memory controller 110 generates address and command signals in the form of data packets. Thereafter, packet controller 120 transforms these data packets (or packet data) into address and control (or command) signals adapted to implement one or more data communication protocols with synchronous memory 130.

In further detail, the term “data packet” refers generally to any packet (or grouping) of data, preferably including address and/or control data to be applied to synchronous memory 130. Data packets are preferably transmitted from memory controller 110 in either a parallel and/or series manner. As shown in the example illustrated in FIG. 1, data packets PKT0[m:0] through PKTn[m:0] are transferred to packet controller 120 during predetermined cycle(s), as defined by clock signal CK (e.g., 2 cycles in one related embodiment). For example, if each data packet is composed of four (4) data bits, it may be transferred from memory controller 110 to packet controller 120 at a rate of one bit per half CK cycle. Packet controller 120 converts the data packet received from memory control 110 into a data form adapted to a protocol required by synchronous memory 130 in accordance with control signals CSB and CKE provided by memory controller 110. When the control signal CSB, i.e., a chip selection signal, becomes active, packet controller 120 begins reception of the data packet from memory controller 110. Thus, control signal CSB acts as a packet enable signal indicating a data packet transmission.

As presently preferred, packet controller 120 transforms an m-bit serial data packet, typically including address and command signals, into an m-bit parallel data packet. In contrast to the parallel transmitted data packet composed of address and command signals, data signals are transferred without a serial-to-parallel conversion. Given this differentiated mode of transmission, as between address/command signals and data signals, packet controller 120 merely passes through the data signals DQ[15:0] transmitted between memory controller 110 and synchronous memory 130. That is, data signals are directly exchanged between memory controller 110 and synchronous memory 130 during read/write operations without packet transformation.

If we assume that packet controller 120 and synchronous memory 130 are implemented within a single package using MCP or SIP technology, then it follows that synchronous memory 130 will include sufficient connection pins to support synchronous memory operations. Thus, an operative synchronous memory pin configuration must include pins accepting address signals, command signals, and data signals, and this is true whether packet controller 120 is present in a particular system or not. Therefore, it can be readily seen that use of packet controller 120, implemented using MIP or SIP, allows for a reduction in the number of pins in an associated synchronous memory, because the packet pins designated as PKT0[3:0] through PKTn[m:0] in the illustrated example effectively merge pin assignments for a multiplicity of command and address signals.

Hereafter, the common assembly of packet controller 120 and synchronous memory 130 on a single substrate will be referred to as “low-pin and low-power RAM” (or L²RAM) because such configurations are characterized in one aspect by a reduced number of pins and a lower overall power consumption. In general, L 2RAM designs are highly applicable to mobile or portable electronic applications.

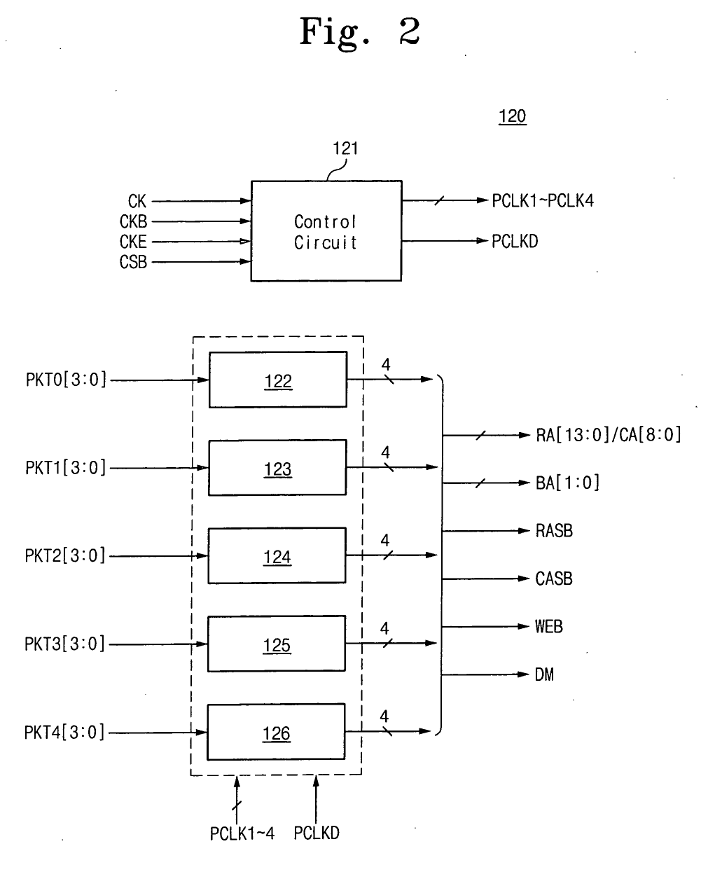

Referring to FIG. 2, packet controller 120 of FIG. 1 is further illustrated as generating five (5) data packets (i.e., n=5), each data packet being preferably composed of 4 bits. However, the actual number of data packets used as well as the number of bits per a packet is a matter of routine design choice.

Packet controller 120, as illustrated in FIG. 2, preferably comprises a control circuit 121 and five (5) serial-to-parallel registers 122 through 126. Control circuit 121 receives clock signals, CK and CKB, and control signals CSB and CKE from memory controller 110, and generates pulse signals PCLK1 through PCLK4, and PCLKD.

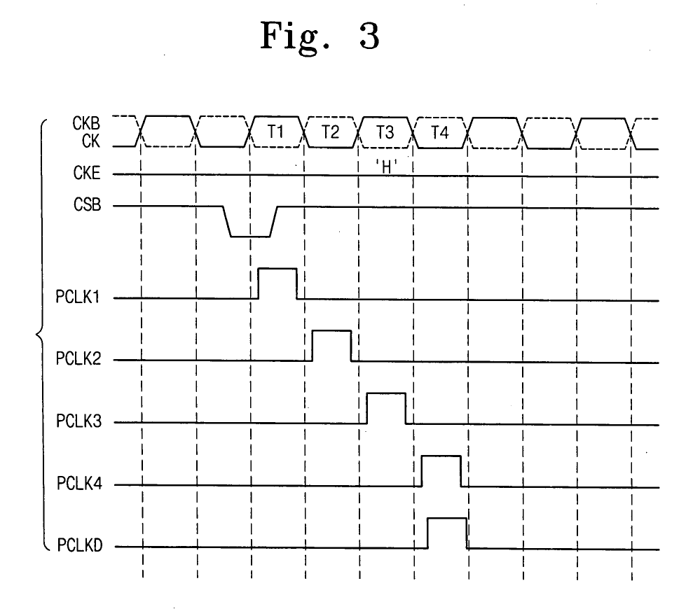

Referring to FIG. 3, pulse signals PCLK1 through PCLK4 are sequentially generated in sync with rising edges of clock signal CK in response to an activation of the chip selection signal, CSB. Pulse signal PCLKD is generated during an activation period of pulse signal PCLK4. Once chip selection signal CSB is active, the data packets are applied to packet controller 120 are deemed valid. Thus, chip selection signal CSB acts as a signal indicating the beginning of a transmission cycle for the data packets.

Returning to FIG. 2, registers 122 through 126 operate in response to the pulse signals supplied from control circuit 121, and respectively receive data packets PKT0[3:0] through PKT4[3:0]. Data packets PKT0[3:0] through PKT4[3:0], each preferably comprising four (4) serially transmitted data bits, are converted into a parallel data form by means of a corresponding register. Once converted into a parallel data form the data packets are applied to synchronous memory 130 as address signals. As illustrated in FIG. 2, address signals include, for example, AD[13:0] and BA[1:0]. Control signals such as RASB (row address strobe signal), CASB (column address strobe signal), WEB (write enable signal), and DM (DQ masking signal) are also applied to synchronous memory 130. Synchronous memory 130 conducts a burst operation in response to the address and control signals supplied in a parallel data form by packet controller 120,

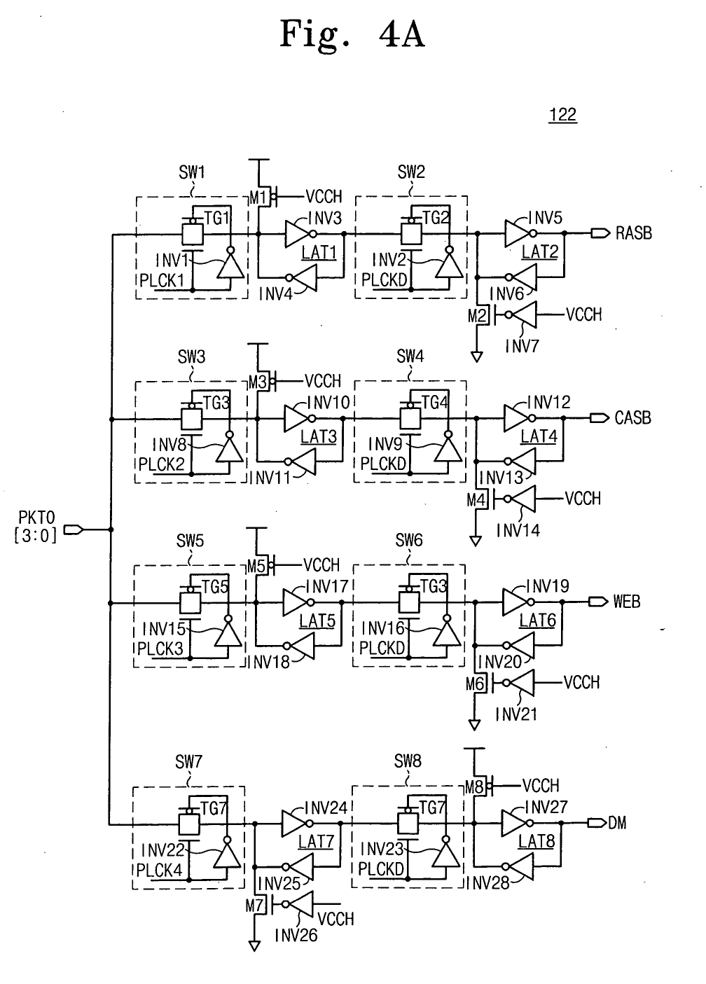

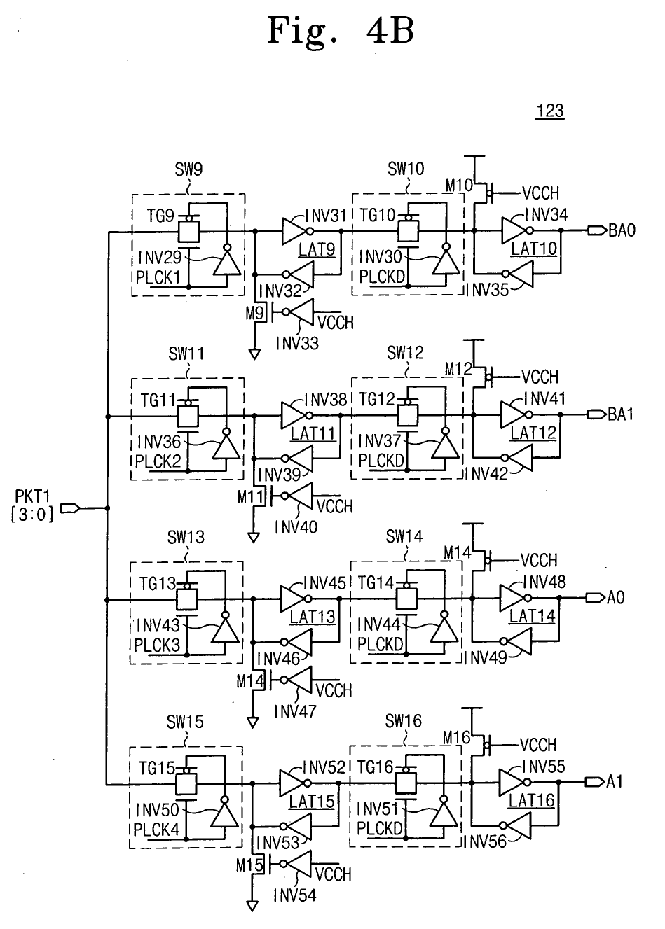

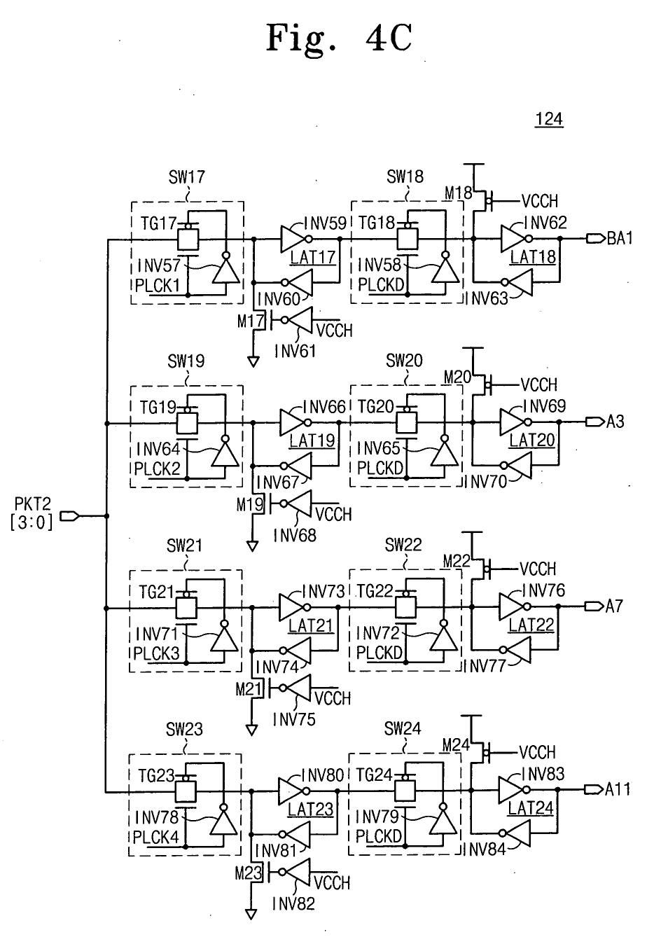

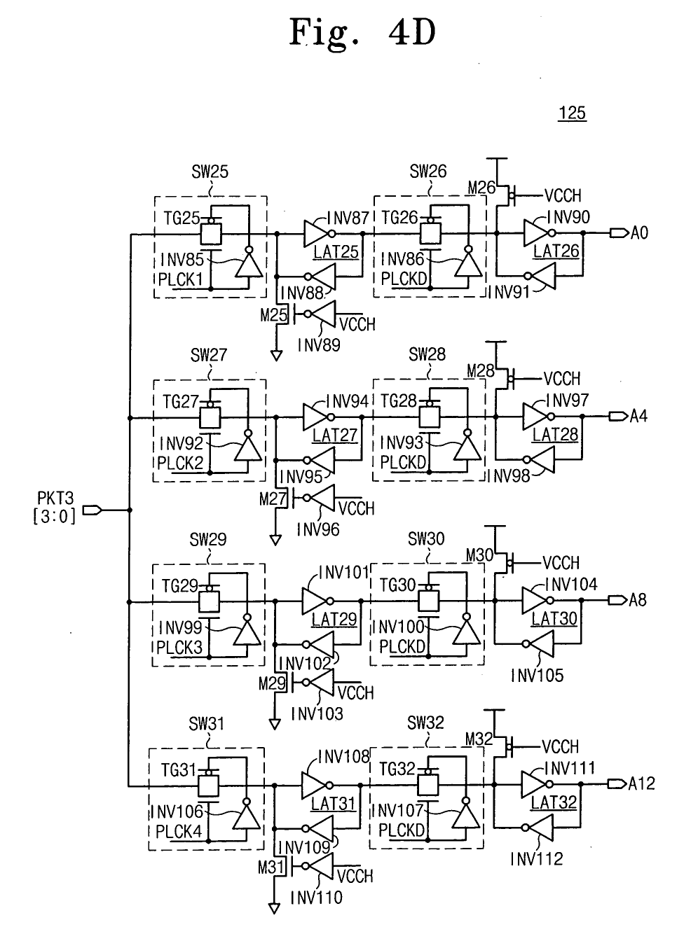

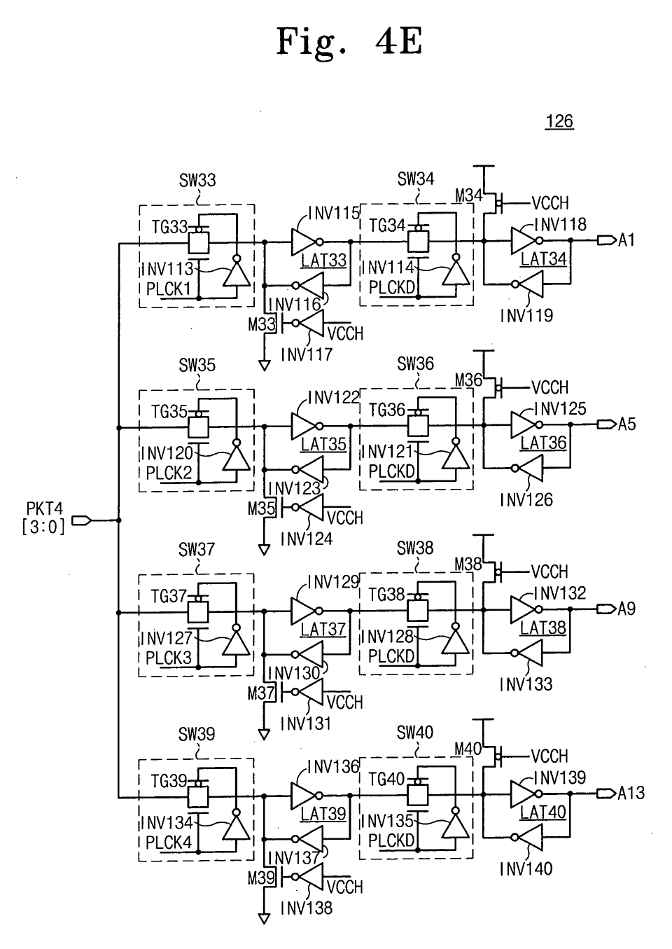

FIGS. 4A through 4E illustrate the serial-to-parallel registers 122 through 126 shown in FIG. 2. These serial-to-parallel registers convert serial data packets into the parallel data packets.

Referring to FIG. 4A, serial-to-parallel register 122, shown here as a representative example of a serial-to-parallel register, comprises a plurality of paired switches SW1 through SW8, a plurality of paired latches LAT1 through LAT8, and a plurality of MOS transistors M1 through M8. Each latch is preferably formed by the illustrated combination of two inverters, and is selectively initialized at a low level or a high level when a control signal VCCH is applied to a corresponding MOS transistor at a low level. Control signal VCCH is a power-on reset signal provided by a conventionally understood power-on detector (not shown).

Assuming that first data packet PKT0[3:0] contains control signal RASB, CASB, WEB, and DM (alternatively, the first data packet may contain an internal chip selection signal CS instead of the DM), a first bit PKT0[0] of first data packet PKT0[3:0], corresponding to RASB, is loaded in latch LAT1 when first pulse signal PCLK1 is applied to switch SW1 at a high level. A second bit PKT0[l] of first data packet PKT0[3:0], corresponding to CASB, is loaded in latch LAT3 when second pulse signal PCLK2 is applied to switch SW3 at a high level. A third bit PKT0[2.] of first data packet PKT0[3:0], corresponding to WEB, is loaded in latch LAT5 when third pulse signal PCLK3 is applied to switch SW5 at a high level. A fourth bit PKT0[3] of first data packet PKT0[3:0], corresponding to DM, is loaded in latch LAT7 when the fourth pulse signal PCLK4 is applied to switch SW7 at a high level.

Following these data transfer operations, and as illustrated in the timing diagram of FIG. 3, when pulse signal PCLKD goes high during a time period T4, during which pulse signal PCLK4 is also high, the foregoing data bits in the first data packet PKT0[3:0] stored in latches LAT1, LAT3, LAT5, and LAT4 are transferred into latches LAT2, LAT4, LAT6, and LAT8 through corresponding switches SW2, SW4, SW6, and SW8, respectively. Thus, the four bits forming the first data packet PKT0[3:0], and which correspond to control signals RASB, CASB, WEB, and DM, are now ready to be transferred from latches LAT2, LAT4, LAT6, and LAT8 in a parallel (or simultaneously applied) form.

The construction and operation of additional registers shown, for example in FIGS. 4B through 4E, are substantially identical to that of of register 122 shown in FIG. 4A. However, the nature of the constituent data bits respectively applied to registers 123, 124, 125, and 126 by the second, third, fourth, and fifth data packet vary in accordance with the overall system design, e.g., see the above description of address and control signals.

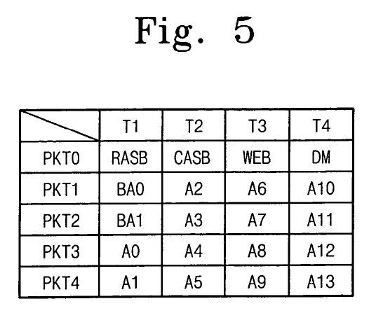

Referring now to FIG. 5, the timing relationship between the exemplary 4 period transmission cycle (T1, T2, T3, and T4) and the constituent signals of the exemplary data packets (PKT0[3:0] through PKT4[3:0]) is further illustrated. This timing relationship also illustrates signal assignments for pin during each transmission period. For example, the first bits of the respective data packets, RASB, BA0, BA1, A0, and A1, are loaded into their corresponding registers 122 through 126 during the first time period T1 when pulse signal PCLK1 is high (or “active”). The second bits of the respective data packets, CASB, A2, A3, A4, and A5, are loaded at into their corresponding registers 122 through 126 during the second time period T2 when pulse signal PCLK2 is high. Next, the third bits of the respective data packets, WEB, A6, A7, A8, and A9, are loaded in their corresponding registers 122 through 126 during the third time period T3 when pulse signal PCLK3 is high. Finally, the fourth bits of the respective data packets, DM, A10, A11, A12, and A13, are loaded in their corresponding registers 122 through 126 during the fourth time period T4 when pulse signal PCLK4 is high.

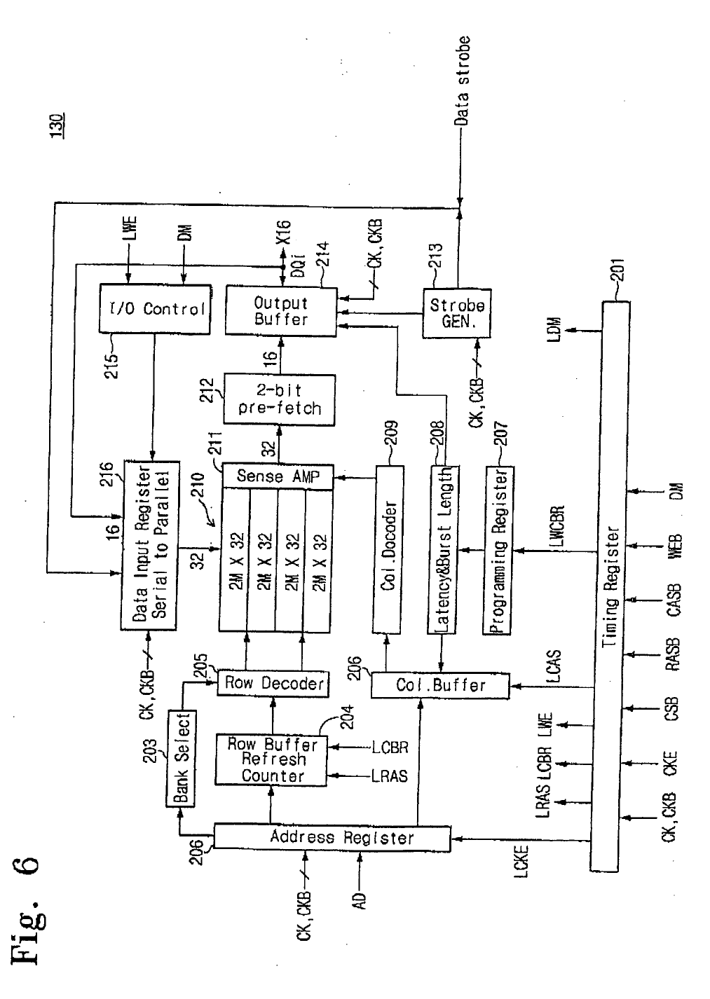

FIG. 6 illustrates an exemplary functional architecture for the synchronous memory 130 of FIG. 1. Operations within this architecture are preferably performed in sync with clock signals CK and CKB received from memory controller 110. Clock signals CK and CKB are applied to a timing register 201, an address register 202, a data strobe generator 213, a data output buffer 214, and a data input register 216.

Although memory controller 110 outputs address and command (or control) signals in packet form, synchronous memory 130, (which is preferably adapted to conventional DDR SDRAM operations), is operable with the address and command (or control) signals as provided from packet controller 120 in accordance with a selected communication protocol of the type typically applied to sync-type memories. In synchronous memory 130, a burst operation is carried out by incrementing column addresses for a fixed row address in sync with the clock signals. An operational frequency for the burst mode is thus defined in relation to clock signal CK.

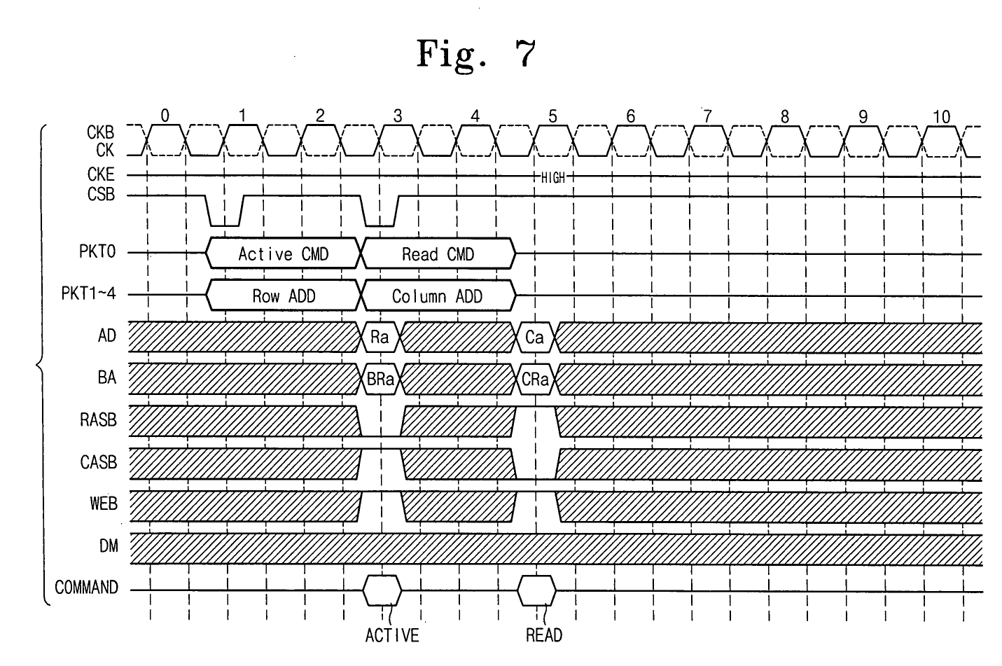

FIG. 7 shows an exemplary operation involving the transfer of data between packet controller 120 and synchronous memory 130. In this example, the operation of packet controller 120 will be described in the context of a read operation. As is typical, the read operation begins when an active command is applied to the memory together with a row address and after a given period of time, a read command is thereafter applied together with a column address. A write operation is analogous to the read operation.

Referring to FIG. 7, in the beginning of the read operation, memory controller 110 supplies packet controller 120 with the 4-bit serial data packets PKT0[3:0] through PKT4[3:0] including the active command and row address together with clock signals CK and CKB, and control signals CKE and CSB. Control circuit 121 of packet controller 120 sequentially generates pulse signals PCLK1 through PCLK4 in response to the control and clock signals, CSB, CKE, CK, and CKB. Registers 122 through 126 of packet controller 120 sequentially latch four data bits of the data packets PKT0[3:0] through PKT4[3:0] in response to pulse signals PCLK1˜PCLK4. The latched data bits in the registers are simultaneously output therefrom when pulse signal PCLKD turns to an active state. The data bits output in parallel from the registers are transferred to synchronous memory 130 as address signals, RA[13:0] (row address) and BA[l:0], and control signals, RASB, CASB, WEB, and DM. As illustrated in FIG. 7, data packets PKT0[3:0] through PKT4[3:0], including the data bits of the active command and the row address, are input to the registers during the first and second cycles (period 1 and 2 indicated in FIG. 7) of clock signal CK, and thereafter transferred to synchronous memory 130. Synchronous memory 130 receives the active command signal and the row address signals during the third cycle (period 3 indicated in FIG. 7) of clock signal CK.

Next, memory controller 110 supplies packet controller 120 with the second 4-bit serial data packets PKT0[3:0] through PKT4[3:0] including the read command and column address together with clock signals CK and CKB and control signals CKE and CSB. Control circuit 121 of packet controller 120 sequentially generates pulse signals PCLK1˜PCLK4 in response to the control and clock signals, CSB, CKE, CK, and CKB. Registers 122 through 126 of packet controller 120 sequentially latch four data bits of the data packets PKT0[3:0] through PKT4[3:0] in response to pulse signals PCLK1 through PCLK4. The latched data bits in the registers are simultaneously output therefrom when pulse signal PCLKD turns to an active state. The data bits output in parallel from the registers are transferred to synchronous memory 130 as the address signals, CA[8:0] (column address) and BA[1:0], and the control signals, RASB, CASB, WEB, and DM. As illustrated in FIG. 7, data packets PKT0[3:0] through PKT4[3:0], including the data bits of the read command and the column address, are input to the registers during the third and fourth cycles (periods 3 and 4 indicated in FIG. 7) of clock signal CK, and then transferred to synchronous memory 130. Synchronous memory 130 receives the read command signal and the column address signal during the fifth cycle (period 5 indicated in FIG. 7) of clock signal CK.

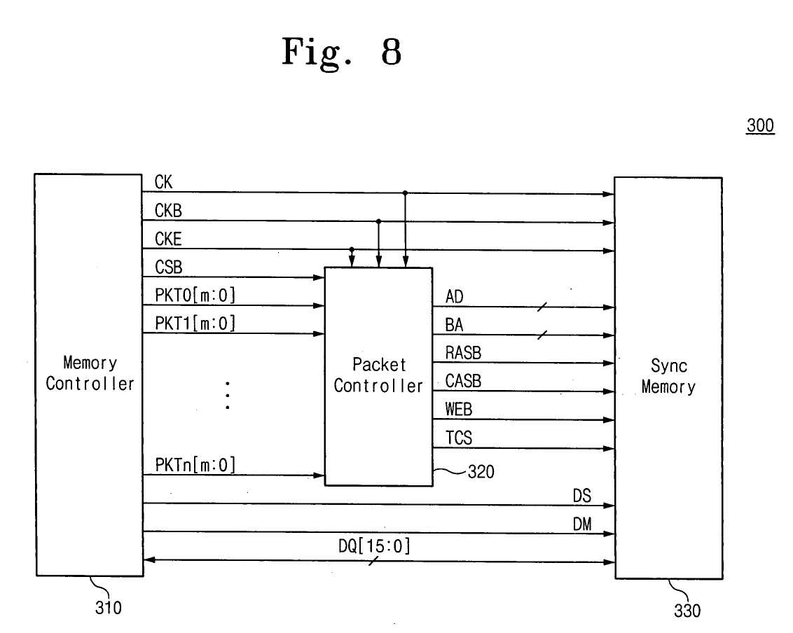

FIG. 8 illustrates a memory system according to another embodiment of the invention.

Referring to FIG. 8, a memory system 300 generally comprises a memory controller 310, a packet controller 320, and a synchronous memory 330.

Like the memory system illustrated in FIG. 1, packet controller 320 forms an interface between memory controller 310 and synchronous memory 330. Synchronous memory 130 is preferably a double (or dual) data rate synchronous DRAM (DDR-SDRAM), or similar synchronous memory type. In memory system 300, packet controller 320 and synchronous memory 330 may be assembled using MCP or SIP technologies. Otherwise, they may be commonly implemented on a single substrate using conventionally understood system-on-chip (SOC) techniques. Both packet controller 320 and synchronous memory 330 are preferably driven by clock signals CK and CKB provided by memory controller 310. Specifically, memory 330 conducts a burst operation in sync with clock signals CK and CKB.

Memory controller 310 generates address and command signals in the form of data packets, and then packet controller 320 transforms the data packets (or packet data) into address and control (or command) signals adapted for use in relation to one or more communication protocols associated with synchronous memory 330.

In the embodiment shown in FIG. 8, data strobe signal DS and the data masking signal DM are transferred to synchronous memory 330 directly from memory controller 310 without connection to or passing through packet controller 320. Data signals DQ[15:0] are also exchanged directly between memory controller 310 and synchronous memory 330 without passing through packet controller 320.

As with former embodiment described in relation to FIG. 1, data packets PKT0[m:0] through PKTn[m:0] contain the address and control signals to be applied in parallel data form to synchronous memory 330. These signals are generated in memory controller 310 in serial data form and thereafter converted from a serial form to a parallel data form. Data packets PKT0[m:0] through PKTn[m:0] are transferred to packet controller 120 in a predetermined transmission cycle as defined by clock signal CK (e.g., 2 cycles in one presently preferred embodiment). For instance, each data packet preferably comprises four data bits transferred from memory controller 310 to packet controller 320 at a rate of one bit per half clock (CK) cycle. Packet controller 320 converts the data packet into a data form acceptable to a defined data transmission (or communications) protocol for synchronous memory 330 in response to control signals CSB and CKE, as provided by memory controller 310. When control signal CSB becomes active, packet controller 320 begins to receive the data packet from memory controller 310. The control signal CSB, i.e., a chip selection signal, acts as a packet enable signal indicating data packet transmission.

The packet controller 320 of FIG. 8 generates control signals RASB, CASB, WEB, and TCS from serial combinations of data bits which are included in a first data packet PKT0[m:0], while the former packet controller 120 of FIG. 1 generates RASB, CASB, WEB, and CSB from the serial combinations of data bits from first data packet PKT0[m:0]. That is, the chip selection signal CSB included in the serial combination of data bits from the first data packet PKT0[m:0] is not applied directly to synchronous memory 330 as shown in FIG. 1, but is converted into an internal chip selection signal TCS by way of packet controller 320. Thus, synchronous memory 330 receives internal chip selection signal TCS from packet controller 320, not the chip selection signal CSB directly from memory controller 310.

Packet controller 320 transforms an m-bit serial data packet, in which address and command signals are combined, into an m-bit parallel data packet. The address and command signals are transferred in packet form, as described above, while data signals DQ[15:0] are directly transferred to synchronous memory 130 without serial-to-parallel conversion by packet controller 320. Data signals DQ[15:0], as read from synchronous memory 330 are also directly transferred to memory controller 310 without passing through packet controller 320. That is, the data signals are directly communicated between memory controller 310 and synchronous memory 330.

Also in this embodiment, packet controller 320 enables a MIP or SIP implementation of the memory system to utilize one or more chips having a reduced pins count, since packet pins of PKT0[3:0] through PKTn[m:0] merges pin assignments for a multiplicity of command and address signals. Otherwise, given a packet controller 320 and synchronous memory 330 combination constructed in a single package using MCP or SIP, synchronous memory 330 would necessarily provide all the pins required to for synchronous memory operations, including pins assigned to address signals, command signals, and the data signals.

Such an assembly of packet controller 320 and synchronous memory 330 on a single substrate will be also referred to as the L²RAM having a reduced number of pins and a lower power consumption. As duly noted, these attributes are particularly desirable in mobile applications, for example.

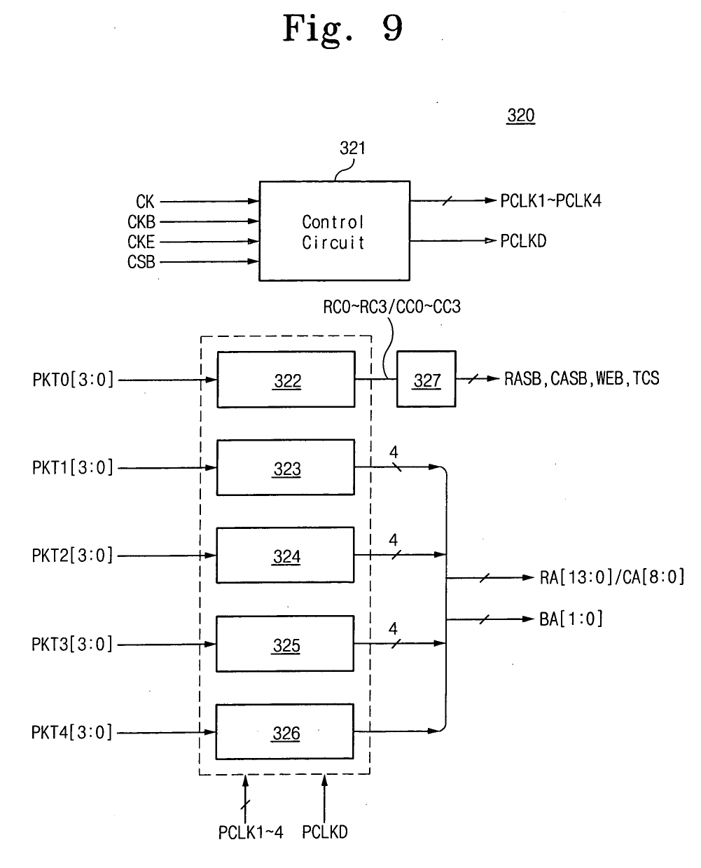

The packet controller 320 of FIG. 8 is shown in some additional detail in FIG. 9. This embodiment of packet controller 320 includes a control circuit 321, five (5) serial-to-parallel registers 322 through 326, and a signal generator 327. Control circuit 321 and the registers 322 through 326 are similarly constructed as the analogous control circuit and registers described in relation to FIG. 2 and FIGS. 4A to 4E. Signal generator 327 receives parallel data bits RC0 through RC3 from first register 322 and then transforms then into control signals RASB, CASB, WEB, and TCS. As with the features described in relation to FIG. 3, clock signals CK and CKB, control signals CSB and CKE, and pulse signals PCLK1˜PCLK4 and PCLKD control operation of packet controller 320. Pulse signal PCLKD is also generated during an activation of pulse signal PCLK4.

In the packet controller 320 shown in FIG. 9, register 322 receives 4-bit command data from a first data packet PKT0[3:0] transmitted by memory controller 320 in series, and converts the command data into parallel data bits RC0 through RC3 that form a row data packet. Then, signal generator 327 outputs control signals RASB, CASB, WEB, and TCS from the parallel data bits RC0 through RC3. Otherwise, when memory controller 310 applies the 4-bit data packet PKT0[3:0] to packet controller 320 in series as a read command, register 322 of packet controller 320 transforms it into parallel data bits CC0 through CC3 that form a column data packet. Then, signal generator 327 turns the parallel data bits CC0 through CC3 into control signals RASB, CASB, WEB, and TCS which are applied to synchronous memory 330.

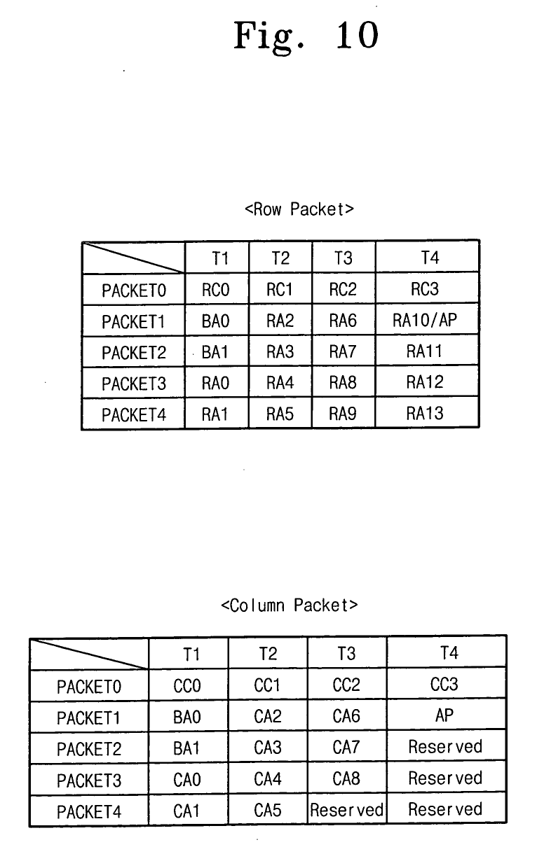

Exemplary signal assignments of the row and column data packets formed by packet controller 320 are summarized in the tables shown in FIGS. 10A and 10B, respectively, in relation to periods (T1 through T4) in a transmission cycle defined by clock signal CK.

First, referring to FIG. 10A, in the case where row data packets are transmitted, the first bits of data packets PKT0[3:0] through PKT4[3:0], RC0, BA0 (a bank address bit), BA1, RA0 (a row address bit), and RA1, are each loaded into registers 322 through 326 during time period T1 when pulse signal PCLK1 is active. In a similar manner, the second bits of data packets PKT0[3:0] through PKT4[3:0], RC1, RA2, RA3, RA4, and RA5, are each loaded into registers 322 through 326 during time period T2 when pulse signal PCLK2 is active. Next, the third bits of the data packets PKT0[3:0] through PKT4[3:0], RC2, RA6, RA7, RA8, and RA9, are each loaded into registers 322 through 326 during time period T3 when pulse signal PCLK3 is active. Finally, the fourth bits of the data packets PKT0[3:0] through PKT4[3:0], RC3, RA10/AP (AP is an auto-precharge command), RA11, RA12, and RA13, are loaded into registers 122 through 26 during time period T4 when pulse signal PCLK4 is active.

Regarding the column data packets as shown in FIG. 10B, the first bits of the data packets PKT0[3:0] through PKT4[3:0], CC0, BA0, BA1, CA0 (a column address bit), and CA1, are loaded into registers 322 through 326 during time period T1 when pulse signal PCLK1 is active. In similar manner, the second bits of the data packets PKT0[3:0] through PKT4[3:0], CC1, CA2, CA3, CA4, and CA5, are loaded into registers 322 through 326 during time period T2 when pulse signal PCLK2 is active. Next, the third bits of the data packets PKT0[3:0] through PKT4[3:0], CC2, CA6, CA7, CA8, and Reserved (preferably not used in this embodiment, are loaded into registers 322 through 326 during time period T3 when pulse signal PCLK3 is active. Finally, the fourth bits of the data packets PKT0[3:0] through PKT4[3:0], CC3, AP, and other Reserved data bits, are loaded into registers 322 through 326 during time period T4 when pulse signal PCLK4 is active.

It can be seen that the embodiment of packet controller 320 described in relation to FIG. 9 is different from the former description made in relation to packet controller 120 of FIG. 2. The uses of signal generator 327 in the later embodiment allows conversion of parallel data bits RC0 through RC3 (or CC0˜CC3) into the control signals RASB, CASB, WEB, and TCS.

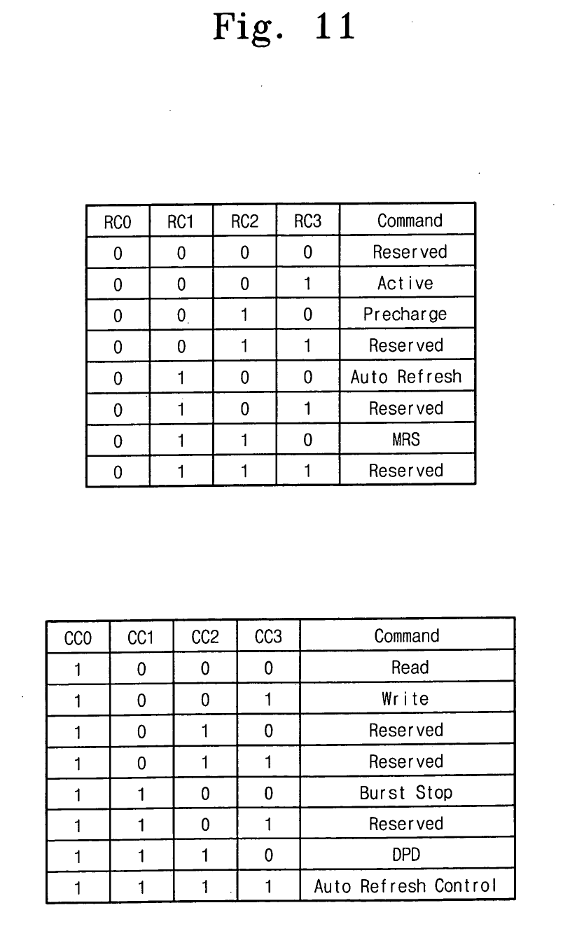

Practical coding patterns for the representative 4-bit data packets including row and column parallel data bits RC0 through RC3 and CC0 through CC3 are tabulated in FIGS. 11A and 11B. Such coding patterns may be used to readily define commands operable within the context of a synchronous memory system designed in accordance with the present invention.

As shown in example set forth in FIG. 11A, row parallel data “1000”, in the order of RC3, RC2, RC1, and RC0, sets a precharge command and “0100” represents an auto-refresh command. Row parallel data “0110” designates a command for beginning an MRS mode. Meanwhile, in FIG. 11B, column parallel data “0001”, in the order of CC3, CC2, CC1, and CC0, corresponds to a read command and the column parallel data “1001” is assigned to a write command. The column parallel data RC3 through RC0 composed of “0111” initiates a deep power-down (DPD) mode. Such bit combinations for establishing various operational commands are evolved from the data packet PKT0[3:0] that is supplied from the memory controller 310.

In the beginning of a read operation, memory controller 310 supplies packet controller 320 with 4-bit, serial data packets PKT0[3:0] through PKT4[3:0] including the active command and row address together with clock signals CK and CKB and control signals CKE and CSB. Control circuit 321 associated with packet controller 320 sequentially generates pulse signals PCLK1 through PCLK4 in response to control and cock signals, CSB, CKE, CK, and CKB. Registers 322 through 326 associated with packet controller 320 sequentially latch four data bits from data packets PKT0[3:0] through PKT4[3:0] in response to pulse signals PCLK1 through PCLK4. The latched data bits in the registers are simultaneously output therefrom when pulse signal PCLKD turns to an active state. And, the signal generator 327 applies control signals RASB, CASB, WEB, and TCS to synchronous memory 330 in response to row parallel data RC0 through RC3 supplied from register 322. The data bits output in parallel from registers 323 through 326 are transferred to synchronous memory 330 as the address signals RA[13:0] and BA[1:0].

The operational timings for signal transmission in this embodiment is similar to the former embodiment. As also illustrated in FIG. 7, data packets PKT0[3:0] through PKT4[3:0], preferably include data bits defining the active command and the row address, are input to registers 322 through 326 during the first and second cycles (periods 1 and 2 indicated in FIG. 7) of clock signal CK, and then transferred to synchronous memory 330. Synchronous memory 330 receives the active command signal and the row address signals during the third cycle (period 3 indicated in FIG. 7) of clock signal CK.

After the active command signal and the row address signals have been supplied to synchronous memory 330, memory controller 310 next supplies packet controller 320 with a set of 4-bit serial data packets PKT0[3:0] through PKT4[3:0] including the read command and column address signals together with clock signals CK and CKB and control signals CKE and CSB. Control circuit 321 associated with packet controller 320 sequentially generates pulse signals PCLK1˜PCLK4 in response to the control and clock signals, CSB, CKE, CK, and CKB. Registers 322 through 326 associated with packet controller 320 sequentially latch four data bits of the data packets PKT0[3:0] through PKT4[3:0] in response to pulse signals PCLK1 through PCLK4. The latched data bits in the registers are simultaneously output therefrom when pulse signal PCLKD turns to an active state, and signal generator 327 applies control signals RASB, CASB, WEB, and TCS to synchronous memory 330 in response to the row parallel data CC0 through CC3 supplied from register 322. The data bits output in parallel from registers 323 through 326 are transferred to synchronous memory 330 as address signals CA[8:0] and BA[1:0].

The operational timings for signal transmission in this embodiment are similar to the former embodiment. As also illustrated in FIG. 7, the second data packets PKT0[3:0] through PKT4[3:0], including the data bits of the read command and the column address, are input to the registers during the third and fourth cycles (periods 3 and 4 indicated in FIG. 7) of clock signal CK, and then transferred to synchronous memory 330. And, synchronous memory 330 receives the read command signal and the column address signal during the fifth cycle (period 5 indicated in FIG. 7) of clock signal CK.

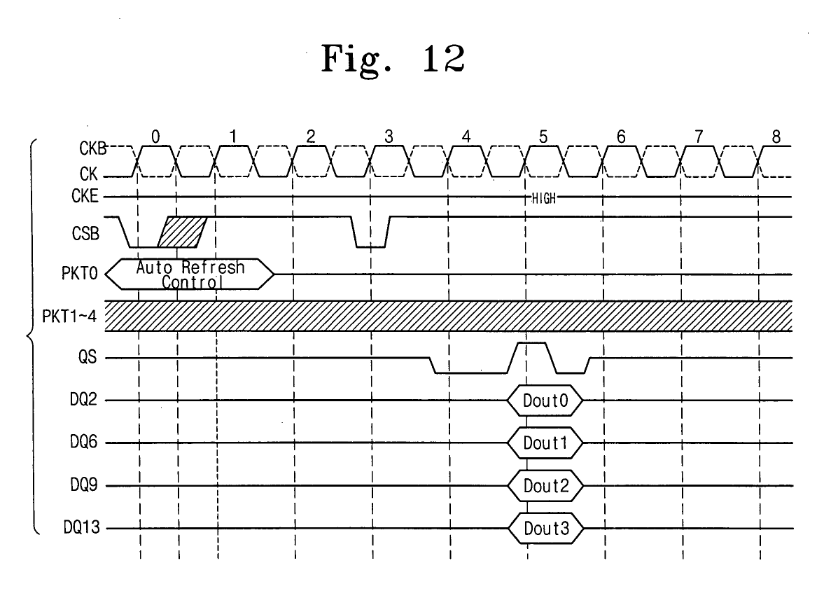

During an auto-refresh operation in those embodiments, as illustrated in FIG. 12, memory controller (110 or 310) transfers an auto-refresh command to packet controller (120 or 320) through data packet PKT0[3:0] without including address signals, which means there is no toggling operations for address transitions at pins of the data packets PKT1[3:0] through PKT4[3:0]. The packet controller generates the control signals in response to the auto-refresh command and synchronous memory (130 or 330) carries out an auto-refresh operation under the control by the control signals.

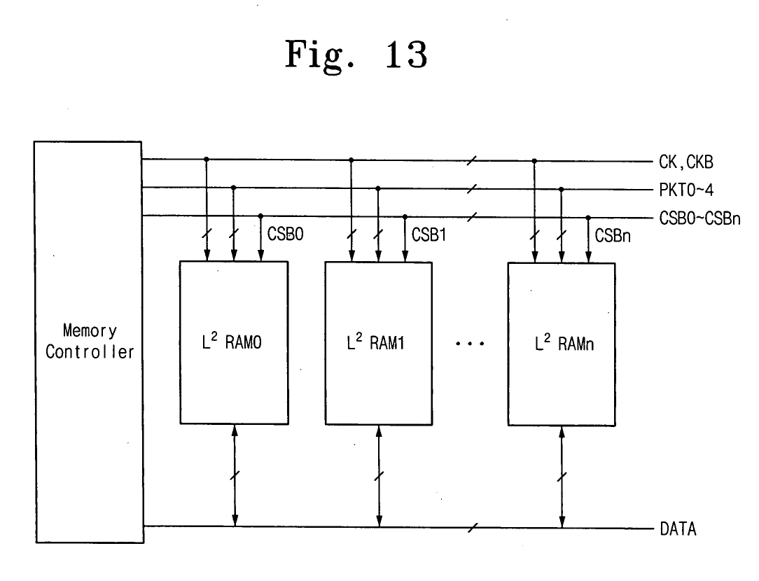

As aforementioned, the chip selection signal provided from the memory controller acts as a packet enable signal to initiate the packet transmission towards the packet controller when the memory controller controls the L²RAM composed of the packet controller and synchronous memory. Meanwhile, when a plurality of the L²RAMs are employed in the form of a module in a memory system as shown in FIG. 13, the chip selection signal functions as selection signals for the L²RAMs, as well as the packet enable signal. Referring to FIG. 13, the chip selection signal is divided into pluralities such as CSB0 through CSBn each corresponding to a particular L2RAM0 through L2RAMn as the packet enable and selection signals.

As described above, the transmission of data packets including the command and the address signals is advantageous in that it allows reduction of the number of pins in a memory system constructed using MCP or SIP techniques.

Although the preferred embodiments of the present invention have been disclosed for illustrative purposes, those skilled in the art will appreciate that various modifications, additions and substitutions are possible, without departing from the scope and spirit of the invention as described in the accompanying claims

What is claimed is:

1. A memory system comprising:
a packet controller, responsive to a packet enable signal and a clock signal, receiving data packets from a memory controller via a plurality of input pins, converting the data packets into address and control signals, and outputting the address and control signals via a plurality of output pins; and
a synchronous memory receiving the address and control signals in response to the clock signal;
wherein the plurality of output pins is fewer in number than the plurality of input pins.

2. The memory system of claim 1, wherein the synchronous memory is adapted to perform burst operations in response to the clock signal.

3. The memory system of claim 1, wherein the synchronous memory and the packet controller are assembled in a single package.

4. The memory system of claim 3, wherein the package is one of a multi-chip package (MCP) and a system-in-package (SIP).

5. The memory system of claim 1, wherein the input pins are locally used for receiving a data packet relevant to a command.

6. The memory system of claim 5, wherein at least one data packet comprises a serial composition of the control signals.

7. The memory system of claim 5, wherein at least one data packet comprises a serial composition of data bits defining the command.

8. The memory system of claim 1, wherein the synchronous memory is a dual data rate synchronous DRAM.

9. The memory system of claim 1, wherein the packet enable signal is a chip selection signal.

10. The memory system of claim 1, wherein the data packets comprises a first data packet comprising data relevant to control signals, and second through fifth data packets comprising data relevant to address signals.

11. The memory system of claim 1, wherein data signals communicated between the memory controller and the synchronous memory are transferred without passing through the packet controller.

12. The memory system of claim 1, wherein the synchronous memory comprises:
an array of memory cells arranged in a matrix of rows and columns;
a row selection circuit designating the rows in response to row address signals provided by the packet controller in response to the clock signal;
a column selection circuit designating the columns in response to column address signals provided by the packet controller in response to the clock signal; and
a write and read circuit for writing data signals into and reading data signals from the memory cells in response to the clock signal.

13. The memory system of claim 2, wherein a common frequency defines the rate at which the data packets are converted into address and control signals and the synchronous memory conducts burst operations.

14. The memory system of claim 1, wherein the control signals comprises a row address strobe signal, a column strobe signal, a write enable signal, and an internal chip selection signal.

15. A memory system comprising:
a packet controller, comprising; a first pin receiving a chip selection signal, a second pin receiving a clock signal; a plurality of input pins receiving data packets from a memory controller, and a plurality of output pins;
wherein in response to a packet enable signal and the clock signal, the packet controller receives the data packets through the plurality of input pins, converts the data packets into address and control signals, and outputs the address and control signals via the plurality of output pins; and
a synchronous memory receiving the address and control signals in response to the clock signal.

16. The memory system of claim 15, wherein at least one pin of the plurality of input pins receives at least one data packet defining a memory system command while at least one other pin in the plurality of input pins receives at least one data packet.

17. The memory system of claim 16, wherein the data packet comprises a serial combination of control signals.

18. The memory system of claim 16, wherein the data packet comprises a serial combination of binary bits.

19. The memory system of claim 15, wherein the plurality of input pins are assigned to receive data packets comprising address signals and data bits defining one or more memory system commands.

20. The memory system of claim 15, wherein the packet controller further comprises:
a plurality of pins transferring data signals;
at least one pin receiving a clock enable signal;
at least one pin receiving a data strobe signal; and
at least one pin receiving a data making signal; and
wherein at least one of the data strobe signal, the data masking signal, the data signals, and the clock enable signal is directly transferred from the memory controller to the synchronous memory without passing through the packet controller.

21. The memory system of claim 15, wherein the synchronous memory is adapted to perform a burst operation in response to the clock signal.

22. The memory system of claim 15, wherein the synchronous memory and the packet controller are assembled in a single package.

23. The memory system of claim 22, wherein the package is one of a multi-chip package (MCO) and a system-in-package (SIP).

24. The memory system of claim 15, wherein the synchronous memory is a dual data rate synchronous DRAM.

25. The memory system of claim 15, wherein the synchronous memory comprises:
an array of memory cells arranged in a matrix of rows and columns;
a row selection circuit designating rows in accordance with row address signals provided by the packet controller in response to the clock signal;
a column selection circuit designating columns in accordance with column address signals provided by the packet controller in response to the clock signal; and
a write and read circuit for writing data signals into and reading data signals from the memory cells in response to the clock signal.

26. The memory system of claim 15, wherein the control signals include at least one of a row address strobe signal, a column strobe signal, a write enable signal, and an internal chip selection signal.

27. A memory system comprising:
a synchronous memory responsive to a clock signal;
a memory controller generating serial data packets and the clock signal; and
a packet controller receiving the serial data packets and converting and multiplexing the serial data packets into parallel data packets comprising address and control signals adapted to control operation of the synchronous memory;
wherein the synchronous memory and the packet controller are assembled in a single package.

28. The memory system of claim 27, wherein the packet controller is configured to transfer data signals between the synchronous memory and the memory controller without data form conversion.

29. The memory system of claim 27, wherein the synchronous memory is adapted to perform a burst operation in response to the clock signal.

30. The memory system of claim 27, wherein the synchronous memory comprises:
an array of memory cells arranged in a matrix of rows and columns;
a row selection circuit designating rows in accordance with row address signals provided by the packet controller in response to the clock signal;
a column selection circuit designating columns in accordance with column address signals provided by the packet controller in response to the clock signal; and
a write and read circuit for writing data signals into and reading data signals from the memory cells in response to the clock signal.

31. The memory system of claim 27, wherein the package is one of a multi-chip package (MCP) and a system-in-package (SIP).

32. The memory system of claim 27, wherein the synchronous memory is a dual data rate synchronous DRAM.

33. A memory system comprising:
a memory controller generating a clock signal, a chip selection signal, and a plurality of data packets;
a packet controller comprising:
a control circuit generating a plurality of pulse signals in response to the chip selection signal;
a plurality of registers each latching data bits from a corresponding data packet in response to the pulse signals and thereafter outputting parallel data signals;
a signal generator outputting control signals in response to the parallel data signals provided at least one of the plurality of registers; and,
a synchronous memory storing data in responsive to the control signals, the data signals, and the clock signal.

34. The memory system of claim 33, wherein the synchronous memory directly exchanges data with the memory controller without the data passing through the packet controller.

35. The memory system of claim 33, wherein the synchronous memory is adapted to perform a burst operation in response to the clock signal.

36. The memory system of claim 35, wherein the synchronous memory comprises:
an array of memory cells arranged in a matrix of rows and columns;
a row selection circuit designating rows in accordance with row address signals provided by the packet controller in response to the clock signal;
a column selection circuit designating columns in accordance with column address signals provided by the packet controller in response to the clock signal; and
a write and read circuit for writing data signals to and reading data signals from the memory cells in response to the clock signal.

37. The memory system of claim 36, wherein the synchronous memory is a dual data rate synchronous DRAM.

38. The memory system of claim 33, wherein at least one of the data packets defines a synchronous memory command.

39. The memory system of claim 38, wherein at least one of the data packets comprises a serial combination of the control signals.

40. The memory system of claim 38, wherein at least one of the data packets comprises a serial combination of the data bits defining the synchronous memory command.

41. The memory system of claim 33, wherein the memory controller outputs a data packet assigned to an auto-refresh command not including address information.

42. The memory system of claim 33, wherein the synchronous memory, the registers, the signal generator, and the control circuit are assembled in a single package which is one of a multi-chip package (MCP) and a system-in-package (SIP).

43. A memory system comprising:
a memory controller generating a clock signal, a plurality of chip selection signals, and a plurality of data packets; and
a plurality of circuits, each circuit comprising a packet controller and synchronous memory, being respectively selected by the chip selection signals, and being operable at a frequency defined in relation to the clock signal,
wherein the packet controller receives the data packets, and wherein at least one of the data packets comprises data defining commands and addresses to be applied to the synchronous memory;
wherein the memory controller directly exchanges data with each synchronous memory in the plurality of circuits.

44. The memory system of claim 43, wherein each one of the plurality of circuits is one of a multi-chip package (MCP) and a system-in-package (SIP).

45. The memory system of claim 43, wherein each packet controller further comprises a plurality of registers receiving a corresponding data packet, wherein each register receives data serially and outputs data in parallel.

46. The memory system of claim 43, wherein at least one of the data packets comprises command information, and at last another one of the data packets comprises address information.

47. The memory system of claim 46, wherein the at least one data packet comprising command information further comprises a serial combination of control signals controlling synchronous memory operations.

48. The memory system of claim 46, wherein the at least one data packet comprising command information further comprises a serial combination of data bits defining command information.
